(19) United States
(12) Patent Application Publication
(10) Pub. No.: US 2018/0076525 A1
(43) Pub. Date: Mar. 15, 2018

(54) ANTENNA AND ELECTRONIC DEVICE

(71) Applicant: Murata Manufacturing Co., Ltd., Nagaokakyo-shi (JP)

(72) Inventors: Kentaro MIKAWA, Nagaokakyo-shi (JP); Hiromitsu ITO, Nagaokakyo-shi (JP)

(21) Appl. No.: 15/807,655

(22) Filed: Nov. 9, 2017

Related U.S. Application Data
(63) Continuation of application No. PCT/JP2016/065239, filed on May 24, 2016.

(30) Foreign Application Priority Data
May 29, 2015 (JP) 2015-110140

(51) Int. Cl. H01Q 7/06; H01Q 1/22; H01Q 1/38

(52) U.S. Cl. CPC H01Q 7/06; H01Q 1/38; H01Q 1/2225

(57) ABSTRACT

An antenna includes a spiral coil conductor with a winding central portion defining a coil opening, and magnetic-substance sheets located along the coil opening. A curving portion or a bending portion is provided in the coil opening and the magnetic-substance sheets are provided in positions except a specific portion that is at least a portion of the curving portion or the bending portion.

### CROSS REFERENCE TO RELATED APPLICATIONS

This application claims the benefit of priority to Japanese Patent Application No. 2015-110140 filed on May 29, 2015 and is a Continuation Application of PCT Application No. PCT/JP2016/065239 filed on May 24, 2016. The entire contents of each application are hereby incorporated herein by reference.

### BACKGROUND OF THE INVENTION

### 1. Field of the Invention

The present invention relates to antennas preferably for use in short-distance wireless communication systems and the like, and to electronic devices including such antennas.

### 2. Description of the Related Art

Coil antennas are typically included as antennas for radio frequency identifier (RFID) tags of a high frequency (HF) band or near field communication (NFC).

International Publication No. WO2011/077878 discloses an antenna including a flexible substrate on which a coil conductor is provided and a magnetic-substance sheet located along the flexible substrate.

FIG. 17 illustrates how the antenna disclosed in International Publication No. WO2011/077878 and a communication-partner antenna are coupled to each other. In FIG. 17, an antenna includes a spiral coil conductor CW whose winding central portion defines a coil opening and a magnetic-substance sheet 10 arranged along the coil opening. The antenna 19 is supported by a support stand 43 over a circuit board 20.

When a communication-partner antenna 301 is positioned as illustrated in FIG. 17, a magnetic flux that occurs from the communication-partner antenna 301 passes through the magnetic-substance sheet 10 of the antenna 19 in an in-plane direction. The magnetic flux, φi, does not contribute to magnetic-field coupling between the antenna 19 and the communication-partner antenna 301. Although a magnetic flux that passes through the coil opening defined by the coil conductor CW, φe, is an effective magnetic flux that contributes to the magnetic-field coupling between the antenna 19 and the communication-partner antenna 301, the magnetic flux φe is weak in the positional relation illustrated in FIG. 17.

### SUMMARY OF THE INVENTION

Preferred embodiments of the present invention provide antennas that enable coupling with a predetermined high coupling coefficient even when a coil opening of a communication-partner antenna and a coil opening of the antenna are not positioned to face each other, and electronic devices including such antennas.

An antenna according to a preferred embodiment of the present invention includes a spiral coil conductor with a winding central portion defining a coil opening and a magnetic-substance sheet located along the coil opening, the coil conductor including a curving portion that curves or a bending portion that bends toward a side on which the magnetic-substance sheet is located, the curving portion or the bending portion being provided in the coil opening, the magnetic-substance sheet being provided in a position except a specific portion that is at least a portion of the curving portion or the bending portion.

An antenna according a preferred embodiment of to the present invention includes a spiral coil conductor with a winding central portion defining a coil opening and a magnetic-substance sheet located along the coil opening, the coil conductor including a curving portion that curves or a bending portion that bends toward a side on which the magnetic-substance sheet is located, the curving portion or the bending portion being provided in the coil opening, an opening, a cut, or a gap of the magnetic-substance sheet being provided in a specific portion that is at least a portion of the curving portion or the bending portion.

According to the preferred embodiments of the present invention, even when the coil opening of the antenna is not positioned to face a coil opening surface of a communication-partner antenna, magnetic fluxes that pass through the coil opening of the antenna and the coil opening of a communication-partner antenna are able to be provided, and the antenna and the communication-partner antenna are able to be coupled to each other with a predetermined high coupling coefficient.

An electronic device according to a preferred embodiment of the present invention includes a casing and an antenna provided inside the casing, the antenna including a spiral coil conductor with a winding central portion defining a coil opening, and a magnetic-substance sheet located along the coil opening, the coil conductor including a curving portion that curves or a bending portion that bends toward a side on which the magnetic-substance sheet is located, the curving portion or the bending portion being provided in the coil opening, the magnetic-substance sheet being provided in a position except a specific portion that is at least a portion of the curving portion or the bending portion.

An electronic device according to a preferred embodiment of the present invention includes a casing and an antenna provided inside the casing, the antenna including a spiral coil conductor with a winding central portion defining a coil opening, and a magnetic-substance sheet located along the coil opening, the coil conductor including a curving portion that curves or a bending portion that bends toward a side on which the magnetic-substance sheet is located, the curving portion or the bending portion being provided in the coil opening, an opening, a cut, or a gap of the magnetic-substance sheet being provided in a specific portion that is at least a portion of the curving portion or the bending portion.

Even when a communication-partner antenna is placed in a position different from that of the antenna of the electronic device, the preferred embodiments of the present invention provide communication between the antenna and the communication-partner antenna.

In an electronic device according to a preferred embodiment of the present invention, the antenna is preferably located along an inner surface of the casing. Accordingly, a special support stand for supporting the antenna may be to be omitted.

In an electronic device according to a preferred embodiment of the present invention, the antenna is preferably located in an end portion of the casing. When communication is performed by bringing the electronic device near a communication-partner device, a distance between the antenna of the electronic device and the communication-partner antenna is able to be shortened and communication characteristics are able to be significantly improved. Further, when a communication-partner device is placed over the electronic device, communication characteristics are able to be significantly improved by separating the antenna of the electronic device and the communication-partner antenna by an adequate distance.

In an electronic device according to a preferred embodiment of the present invention, a plane conductor along the antenna is preferably further included, the plane conductor being closer to the magnetic-substance sheet than to the coil conductor. Accordingly, ineffective magnetic fluxes that do not contribute to coupling are able to be controlled and thus, effective magnetic fluxes are able to be increased while significantly improving a coupling coefficient.

According to the preferred embodiments of the present invention, even when the coil opening of the antenna is not positioned to face the coil opening of a communication-partner antenna, magnetic fluxes that pass through the coil opening of the antenna and the coil opening of a communication-partner antenna are able to be provided, and the antenna and the communication-partner antenna are able to be coupled to each other with a predetermined high coupling coefficient to enable communication.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1A is a plan view of an antenna 21 before bending and FIG. 1B is a cross-sectional view taken along B-B in FIG. 1A.

FIG. 2A is a perspective view that illustrates a side of a circuit board, where the antenna according to a first preferred embodiment of the present invention is provided. FIG. 2B is a front view that illustrates a structure of an antenna device including the antenna.

FIG. 3 schematically illustrates a magnetic flux that passes through the antenna according to the first preferred embodiment of the present invention.

FIG. 4 schematically illustrates magnetic fluxes that pass through the antenna according to the first preferred embodiment of the present invention.

FIG. 5 is a front view that illustrates a structure of an antenna device including an antenna according to a second preferred embodiment of the present invention.

FIG. 6 is a front view that illustrates a structure of an antenna device including an antenna according to the second preferred embodiment of the present invention.

FIG. 7 is a front view that illustrates a structure of an antenna device including an antenna according to a third preferred embodiment of the present invention.

FIG. 8 is a vertical cross-sectional view of an electronic device including an antenna according to a fourth preferred embodiment of the present invention.

FIG. 9 is a front view that illustrates a main portion of an electronic device according to a fifth preferred embodiment of the present invention.

FIGS. 10A, 10B and 10C are each a plan view of an antenna according to a sixth preferred embodiment of the present invention before bending.

FIG. 11 is a front view of an antenna according to a seventh preferred embodiment of the present invention.

FIG. 12 is an exploded plan view of the antenna before attaching magnetic-substance sheets to a flexible substrate.

FIG. 13 is a front view that illustrates a main portion of the inside of an electronic device including an antenna according to an eighth preferred embodiment of the present invention.

FIG. 14 is an exploded plan view of the antenna before attaching magnetic-substance sheets to a flexible substrate.

FIG. 15 is a front view that illustrates a main portion of the inside of an electronic device including an antenna according to the eighth preferred embodiment of the present invention.

FIG. 16 is an exploded plan view of the antenna before attaching the magnetic-substance sheets to the flexible substrate.

FIG. 17 illustrates how the antenna disclosed in International Publication No. WO2011/077878 and a communication-partner antenna are coupled to each other.

### DETAILED DESCRIPTION OF THE PREFERRED EMBODIMENTS

Preferred embodiments of the present invention are described below with specific examples by referring to the drawings. It is to be noted that the following preferred embodiments represent examples of the present invention for merely illustrative purposes, and that the present invention is not limited to matters disclosed in the following preferred embodiments. In the drawings, identical references are given to identical portions. Although, the preferred embodiments are separately described for convenience in view of ease in explaining or understanding main points, configurations presented in different preferred embodiments may be partially replaced or combined. In the second preferred embodiment and the preferred embodiments thereafter, descriptions of matters in common with those in the first preferred embodiment are omitted and only different points are described. In particular, similar effects and advantages brought by similar configurations are not mentioned in all preferred embodiments one by one.

In each preferred embodiment of the present invention discussed below, an “antenna device” denotes an antenna that emits a magnetic flux. The antenna device is an antenna that performs proximate-field communication by magnetic-field coupling with a communication-partner antenna, and for example, is utilized for communication, such as a near field communication (NFC). The antenna device operates in a frequency band lower than an ultrahigh frequency (UHF) band, such as a high frequency (HF) band, which is used for communication such as NFC, and particularly at a frequency of 13.56 MHz or a frequency near 13.56 MHz, for example. The antenna device is sufficiently small in size in comparison with a wave length λ at a communication frequency, and emission characteristics of electromagnetic waves are unfavorable in a communication frequency band. The length of a coil conductor of a coil antenna included in an antenna device, which is described below, from one end to the other end of the coil conductor along the coil conductor preferably is about λ/10 or less and is sufficiently short in comparison with a wave length in the communication frequency band and thus, no distribution or substantially no distribution of current in the coil conductor occurs on an axis of coordinates along the coil conductor and an approximately fixed amount of current flows. The wave length here denotes an effective wave length that takes wave length shortening effect into account, which depends on the dielectricity or magnetic permeability of a base material from which the antenna is provided. Both ends of the coil conductor of the coil antenna are coupled to a feeding circuit that operates the communication frequency band, which is an HF band, preferably a band near 13.56 MHz, for example. The coil conductor of the coil antenna and the feeding circuit may be coupled to each other through magnetic-field coupling by a feeding coil or a transformer, such as a balun. In this case, both ends of a coil conductor of the feeding coil or the transformer are coupled to the feeding circuit and both ends of the coil antenna are coupled to each other directly or with a capacitor interposed therebetween.

An “electronic device” is an electronic device that includes the antenna as described above. Various examples of the electronic devices include a mobile phone terminal, such as a smartphone or a feature phone, a wearable terminal, such as a smartwatch or smartglasses, a notebook computer, a tablet terminal, a camera, a game machine, a toy, an information medium, such as an integrated-circuit (IC) tag, a Secure Digital (SD) card, a subscriber identity module (SIM) card, or an IC card.

### FIRST PREFERRED EMBODIMENT

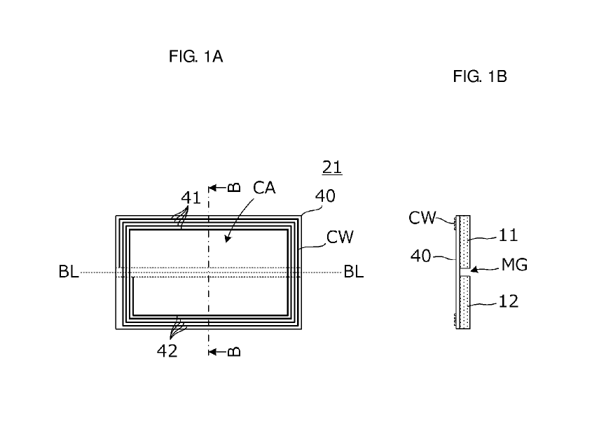

FIG. 1A is a plan view of an antenna 21 before bending and FIG. 1B is a cross-sectional view taken along B-B in FIG. 1A. The antenna 21 includes a flexible substrate 40 on which a coil conductor CW is provided, and magnetic-substance sheets 11 and 12. The coil conductor CW is a rectangular or substantially rectangular spiral coil conductor with a winding central portion that defines a coil opening CA. The coil conductor CW is located so that a first conductor portion 41 and a second conductor portion 42 face each other across a bending line BL-BL that passes through the coil opening CA. The magnetic-substance sheets 11 and 12 are each preferably formed into a rectangular or substantially rectangular sheet from a mixture of magnetic-substance powder, such as ferrite powder, and a resin material. The coil conductor CW and the magnetic-substance sheets 11 and 12 are not necessarily rectangular and the outside shapes thereof may each be an oval or substantially oval shape or a shape including a projecting portion or a depressed portion.

The magnetic-substance sheets 11 and 12 are located along the coil opening CA. Between the magnetic-substance sheet 11 and the magnetic-substance sheet 12, a gap MG, which is a portion without any magnetic-substance sheet, is formed. Specifically, the magnetic-substance sheets 11 and 12 are each pasted over the flexible substrate 40 with a double-faced adhesive sheet interposed therebetween. The location of the gap MG of the magnetic-substance sheets corresponds to a position through which the bending line BL-BL passes. The location of the gap MG is an example of a “specific portion”.

At the time of the bending, the flexible substrate 40 on which the coil conductor CW is provided is bent according to the bending line BL-BL toward a side on which the magnetic-substance sheet 11 is located.

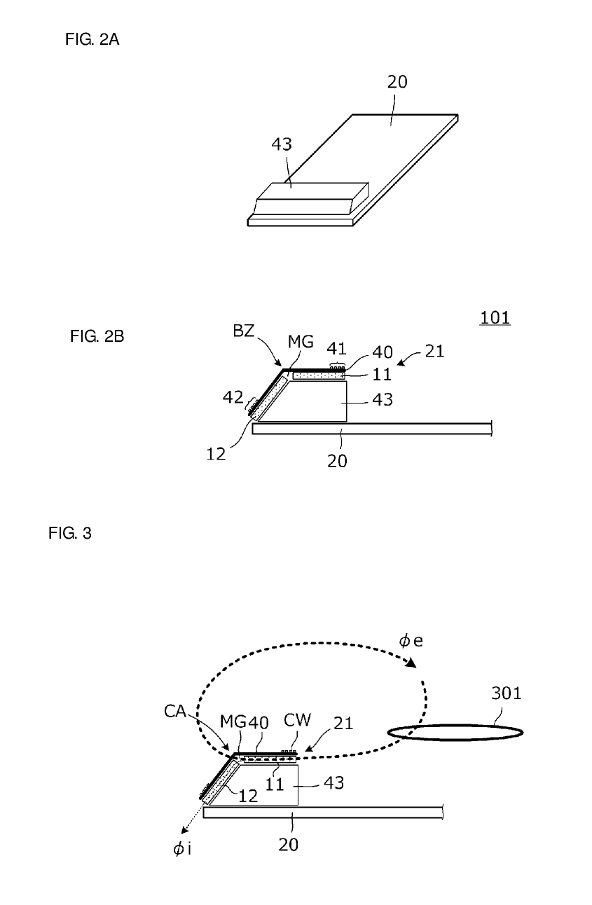

FIG. 2A is a perspective view that illustrates a side of the circuit board, where the antenna according to a first preferred embodiment of the present invention is provided. FIG. 2B is a front view that illustrates a structure of an antenna device 101 including the antenna 21.

The antenna device 101 includes the antenna 21, a support stand 43 that supports the antenna 21, and a circuit board 20 with a rectangular or substantially rectangular shape. The antenna 21 is attached to the support stand 43 illustrated in FIG. 2A.

A ground conductor is defined on the circuit board 20 and extends in a plane.

In the antenna 21, the magnetic-substance sheets 11 and 12 are oriented toward the circuit board 20 from the flexible substrate 40. That is, the magnetic-substance sheets 11 and 12 are pasted on the support stand 43.

As illustrated in FIGS. 2A and 2B, the antenna 21 and the support stand 43 are located near one side of the circuit board 20. The antenna 21 is bent in the bending portion BZ in a direction in which a side of the antenna 21 close to the one side of the circuit board 20 further approaches the circuit board. That is, the coil conductor CW bents toward the side on which the magnetic substance 11 is located and on a side of the face opposite the magnetic-substance sheets 11 and 12, a normal perpendicular or substantially perpendicular to a surface of the coil conductor CW that includes the first conductor portion 41 and a normal perpendicular or substantially perpendicular to a surface of the coil conductor CW that includes the second conductor portion 42 intersect. In the example of FIG. 2B, the second conductor portion 42 is located closer to the one side of the circuit board 20 than the first conductor portion 41.

A unit where the antenna 21 is pasted on the support stand 43 may be mounted on the circuit board 20. Both ends of the coil conductor of the antenna 21 are coupled to predetermined terminal electrodes on the circuit board.

FIG. 3 schematically illustrates a magnetic flux that passes through the antenna 21 according to the first preferred embodiment. A communication-partner antenna 301, such as an RFID tag, is placed near the antenna 21. In the present example, the communication-partner antenna 301 includes a coil opening surface parallel or substantially parallel to a surface of the magnetic-substance sheet 11 and is positioned away from the gap MG of the magnetic-substance sheets to a side of the magnetic-substance sheet 11, that is, in a direction in which the magnetic-substance sheet 11 extends. The coil opening surface of the communication-partner antenna 301 may be perpendicular or substantially perpendicular to the surface of the magnetic-substance sheet 11 and positioned away from the gap MG of the magnetic-substance sheets to the side of the magnetic-substance sheet 11 while the angle of the communication-partner antenna 301 is not limited except an angle that makes coupling between the antenna 21 according to the first preferred embodiment and the communication-partner antenna 301 null (no coupling).

The broken arrow line in FIG. 3 schematically indicates a path of a magnetic flux φe from the communication-partner antenna 301. As illustrated in FIG. 3, the magnetic flux φe passes through the magnetic-substance sheet 11 and escapes from the gap MG. That is, the magnetic flux φe passes through the coil opening CA without passing through the magnetic-substance sheet 12. Consequently, the communication-partner antenna 301 and the antenna 21 perform magnetic-field coupling through the magnetic flux φe.

Thus, among the magnetic fluxes from the communication-partner antenna 301, the proportion of the magnetic fluxes φe that pass through the coil opening CA increases and accordingly, the communication-partner antenna 301 and the antenna 21 perform magnetic-field coupling with a high coupling coefficient.

The example illustrated in FIG. 3 corresponds to a case where communication is performed while the antenna according to the first preferred embodiment is located near an end portion inside the casing of the electronic device and a communication-partner antenna is placed relatively near a central portion of the casing. For example, it is particularly effective when an item or a product with an RFID tag that includes a communication-partner antenna is placed near the center of the electronic device so that the electronic device reads the RFID. It is also effective when communication is performed by holding a portion adjacent to or in a vicinity of the center of the electronic device against an antenna of a reader/writer. That is, the electronic device that includes the antenna according to the first preferred embodiment is able to perform communication not only when a communication-partner antenna is placed near an end portion of the casing but also when the communication-partner antenna is placed near a central portion of the casing.

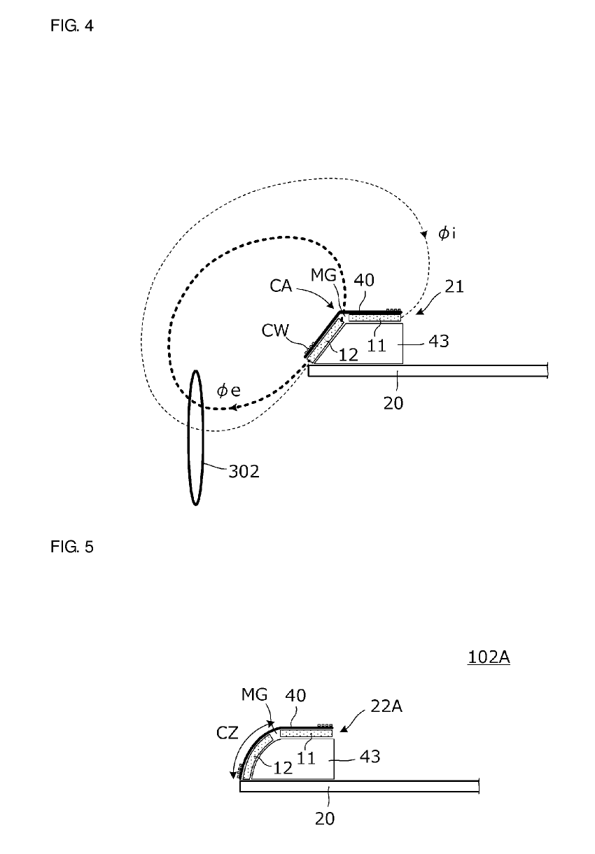

FIG. 4 schematically illustrates magnetic fluxes that pass through the antenna 21 according to the first preferred embodiment. The position of a communication-partner antenna 302 is different from the position of the antenna 301 illustrated in FIG. 3. In the present example, the communication-partner antenna 302 includes a coil opening surface not parallel or not substantially parallel to a surface of the magnetic-substance sheet 12 and is positioned away from the gap MG of the magnetic-substance sheets to a side of the magnetic-substance sheet 12, that is, in a direction in which the magnetic-substance sheet 12 extends. Even when the communication-partner antenna 301 is placed at the position illustrated in FIG. 4, the angle of the communication-partner antenna 301 is not limited except an angle that makes coupling between the antenna 21 according to the first preferred embodiment and the communication-partner antenna 301 null (no coupling).

The broken arrow line in FIG. 4 schematically indicates paths of magnetic fluxes φe and φi from the communication-partner antenna 302. As illustrated in FIG. 4, the magnetic flux φe passes through the magnetic-substance sheet 12 and escapes from the gap MG. That is, the magnetic flux φe passes through the coil opening CA without passing through the magnetic-substance sheet 11. Consequently, the communication-partner antenna 302 and the antenna 21 perform magnetic-field coupling through the magnetic flux φe. Among the magnetic fluxes from the communication-partner antenna 302, by providing the gap MG for the magnetic-substance sheet 12, the proportion of loops of the ineffective magnetic fluxes φi that do not contribute to coupling decreases and the proportion of loops of the effective magnetic fluxes φe that contribute to coupling increases. Accordingly, the communication-partner antenna 302 and the antenna 21 perform magnetic-field coupling with a high coupling coefficient.

Although the example described above relates to cases where magnetic fluxes occur from the communication-partner antenna 302, the example described above also applies to cases where magnetic fluxes occur from the antenna 21.

In addition to the possibility of coupling between a communication-partner antenna and the antenna according to the present preferred embodiment with a predetermined high coupling coefficient, the present preferred embodiment is able to achieve the effects and advantages described below. That is, in the antenna with a related-art structure illustrated in FIG. 17, when the magnetic-substance sheet 10 and the flexible substrate 40 are pasted on each other, the bending of the antenna 19 generates stress on the bending portion BZ (see FIG. 2B). Because of the stress, the magnetic-substance sheet and the flexible substrate 40 are easily separated from each other. In contrast, according to the present preferred embodiment, no magnetic-substance sheet is present in a portion corresponding to the bending line BL-BL and thus, no stress or substantially no stress acts on the bending portion BZ and it is unlikely that the magnetic-substance sheet and the flexible substrate 40 will be separated from each other.

### SECOND PREFERRED EMBODIMENT

A second preferred embodiment of the present invention includes a structure of a bending portion of an antenna is different from that in the first preferred embodiment.

FIG. 5 is a front view that illustrates a structure of an antenna device 102A including an antenna 22A. The antenna device 102A includes the antenna 22A, and a support stand 43 that supports the antenna 22A, and a circuit board 20 with a rectangular or substantially rectangular shape. The shapes of the support stand 43 and the antenna 22A are different from those in the antenna device 101 illustrated in FIG. 2A for the first preferred embodiment.

The support stand 43 of the antenna device 102A includes a curving portion and the antenna 22A is shaped along the support stand 43. Accordingly, the antenna 22A includes a curving portion CZ. The gap MG of magnetic-substance sheets is in the curving portion CZ.

The preferred embodiments of the present invention are not limited to the gap MG of the magnetic-substance sheets is in the bending portion BZ as in the first preferred embodiment, but as in the present preferred embodiment, is able to be applied to cases where the gap MG of the magnetic-substance sheets is in a curving portion with a certain expanse to bring similar effects and advantages.

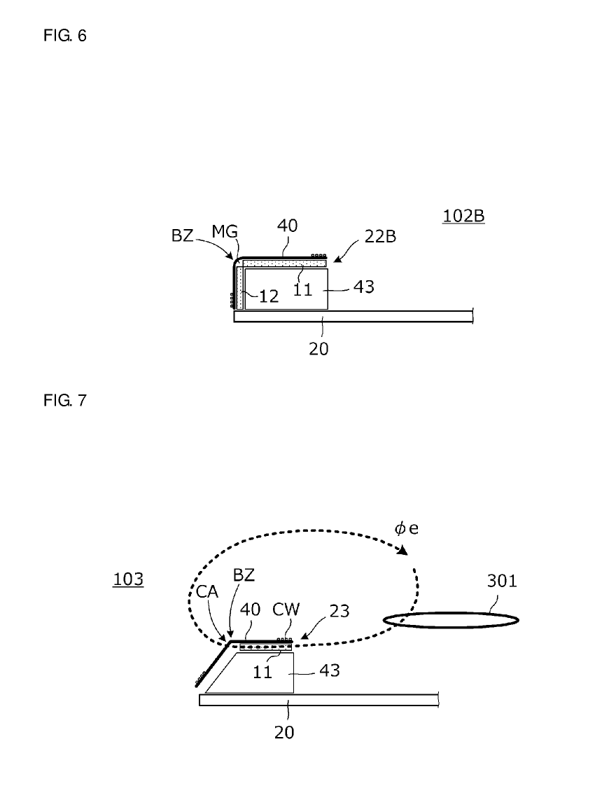

FIG. 6 is a front view that illustrates a structure of an antenna device 102B including an antenna 22B. The antenna device 102B includes the antenna 22B, a support stand 43 that supports the antenna 22B, and the circuit board 20 with a rectangular or substantially rectangular shape. The shapes of the support stand 43 and the antenna 22B are different from those in the antenna device 101 illustrated in FIG. 2A for the first preferred embodiment.

The support stand 43 of the antenna device 102B includes two surfaces orthogonal or substantially orthogonal to each other and the antenna 22B is shaped along the support stand 43. Thus, the antenna 22B is bent at a right angle or at a substantially right angle. The gap MG of the magnetic-substance sheets is in a bending portion BZ due to the bending. In a ridge portion, rounding with a predetermined curvature occurs. As a result, no stress or substantially no stress acts on the magnetic-substance sheet 11 or 12 and it is unlikely that the magnetic-substance sheets 11 and 12, and the flexible substrate 40 will be separated from each other.

### THIRD PREFERRED EMBODIMENT

A third preferred embodiment of the present invention includes a structure of a bending portion of an antenna is different from that in the first preferred embodiment.

FIG. 7 is a front view that illustrates a structure of an antenna device 103 including an antenna 23. The antenna device 103 includes the antenna 23, a support stand 43 that supports the antenna 23, and a circuit board 20 with a rectangular or substantially rectangular shape. Unlike the antenna 21 illustrated in FIG. 2B for the first preferred embodiment, the antenna 23 does not include the magnetic-substance sheet 12 and is provided with the magnetic-substance sheet 11 only. Other features and elements of the antenna 23 preferably are the same as or similar to the features and elements of the antenna 21.

A communication-partner antenna 301, such as an RFID tag, is placed near the antenna 23. As in the example illustrated in FIG. 7, the communication-partner antenna 301 includes a coil opening surface parallel or substantially parallel to a surface of the magnetic-substance sheet 11 and is positioned away from the bending portion BZ in a direction of the magnetic-substance sheet 11. Even when the communication-partner antenna 301 is positioned as illustrated in FIG. 7, the angle of the communication-partner antenna 301 is not limited except an angle that makes coupling between the antenna 23 according to the third preferred embodiment and the communication-partner antenna 301 null (no coupling).

The broken arrow line in FIG. 7 schematically indicates a path of a magnetic flux φe that passes through the communication-partner antenna 301. As illustrated in FIG. 7, the magnetic flux φe passes through the magnetic-substance sheet 11 and passes through the coil opening CA. Thus, the communication-partner antenna 301 and the antenna 23 perform magnetic-field coupling through the magnetic flux φe. Since ineffective magnetic fluxes that do not contribute to coupling hardly occur, the communication-partner antenna 301 and the antenna 23 perform magnetic-field coupling with a high coupling coefficient.

### FOURTH PREFERRED EMBODIMENT

A fourth preferred embodiment of the present invention includes an example of an electronic device.

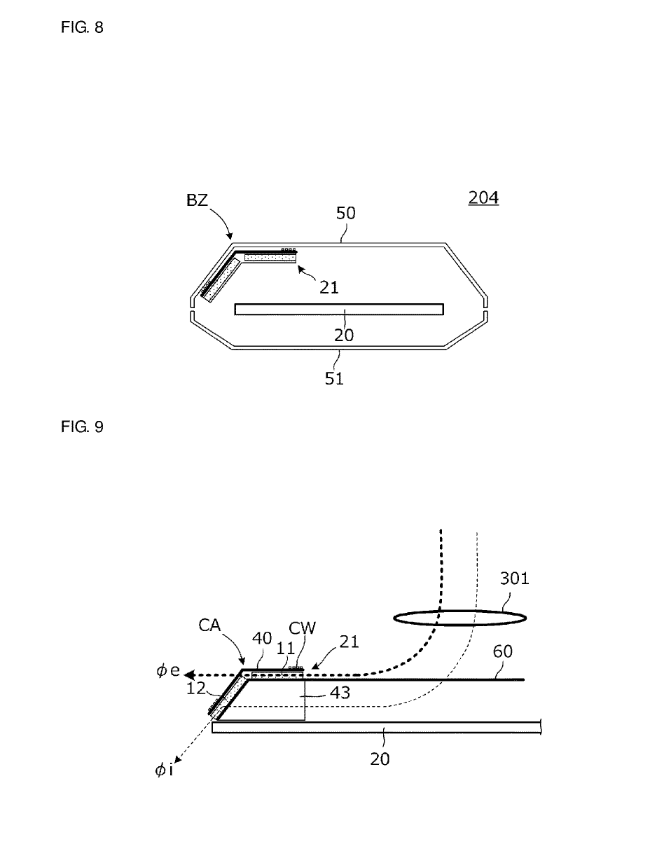

FIG. 8 is a vertical cross-sectional view of an electronic device 204 including an antenna 21. The electronic device 204 includes casings 50 and 51, and the antenna 21. Inside the casings 50 and 51, a circuit board 20 is accommodated. The antenna 21 is described above in the first preferred embodiment. The antenna 21 is located along an inner surface of the casing 50. The casing 50 includes a bending portion and as the antenna 21 is located along an inner surface of the casing 50, a bending portion BZ is provided in the antenna 21. The antenna 21 is bent so that an angle of the antenna 21 in an inner side portion of the casing is smaller than an angle of the antenna 21 in an outer side portion of the casing. The antenna 21 is attached to the inner surface of the casing 50 with for example, a double-surface adhesive sheet interposed therebetween. A feeding circuit provided on the circuit board 20 and the antenna 21 are coupled to each other with a movable probe (e.g., a spring pin) or the like interposed therebetween.

Thus, the structure in which the antenna 21 is located along the inner surface of the casing 50 enables a special support stand for supporting the antenna to be omitted.

As illustrated in FIG. 8, the antenna 21 is located in an end portion of the casing. When communication is performed by bringing the electronic device 204 near a communication-partner device, the structure is able to shorten a distance between the antenna of the electronic device and the communication-partner antenna and significantly improved communication characteristics. Further, when a communication-partner device is placed over the electronic device, communication characteristics are able to be significantly improved by separating the antenna of the electronic device and the communication-partner antenna by an adequate distance.

### FIFTH PREFERRED EMBODIMENT

A fifth preferred embodiment of the present invention includes an electronic device including a plane conductor.

FIG. 9 is a front view that illustrates a main portion of the electronic device according to the present preferred embodiment. The electronic device includes a plane conductor 60 along an antenna 21. The plane conductor 60 is, for example, a shield plate or a battery pack that covers a predetermined region of a circuit board 20. The antenna 21 is described above in the first preferred embodiment.

The plane conductor 60 is located closer to magnetic-substance sheets 11 and 12 than a coil conductor CW of the antenna 21. Accordingly, the plane conductor 60 significantly reduces or prevents an occurrence of an ineffective magnetic flux φi that does not pass through a coil opening CA of the coil conductor CW. Consequently, effective magnetic fluxes increase to significantly improve a coupling coefficient.

### SIXTH PREFERRED EMBODIMENT

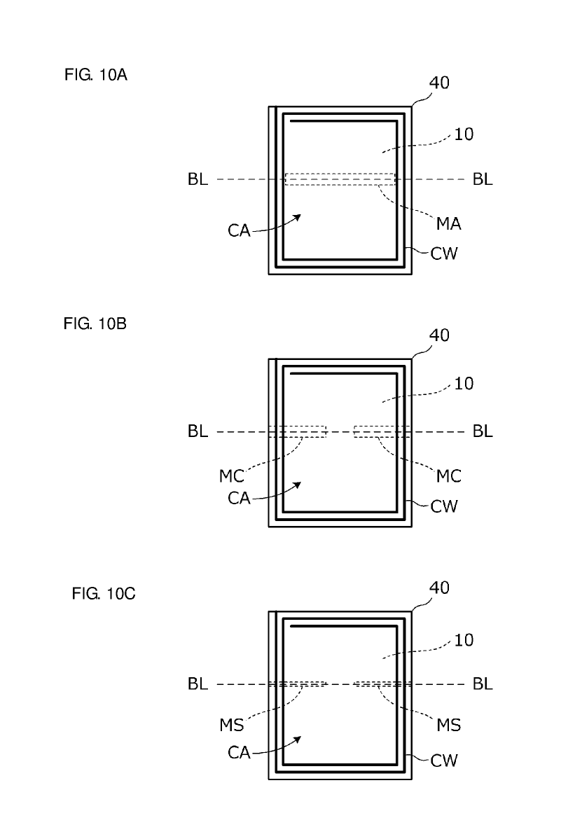

A sixth preferred embodiment of the present invention includes a magnetic-substance sheet is different from those in the first to fifth preferred embodiments described above. FIGS. 10A, 10B and 10C are each a plan view of an antenna according to the present preferred embodiment before bending.

In the example illustrated in FIG. 10A, a slit opening MA along a bending line BL-BL is provided through a magnetic-substance sheet 10. The opening MA is provided over or substantially over a full width of a coil opening CA. The location of the opening MA is an example of the “specific portion”. The “full width of the coil opening CA” denotes the length of the coil opening CA in a direction perpendicular or substantially perpendicular to a bending direction of the bending in a bending portion or the curving in a curving portion, that is, in a direction along the bending line BL-BL. The same or similar features apply to a “full width of the coil opening CA”, which is described below.

Thus, the opening MA through the magnetic substance along the bending line BL enables magnetic fluxes to escape from a portion without the magnetic substance, that is, from the opening MA in the bending portion. In other words, magnetic fluxes escape with efficiency. Although a portion of the magnetic-substance sheet remains in an outside portion of the coil opening CA, this portion does not define the opening of the coil and therefore applies little or no influence on the ease with which the magnetic fluxes escape.

The opening MA is not necessarily provided over the full width of the coil opening CA and may be provided only over a portion of the full width of the coil opening CA. The opening MA may extend beyond the coil opening CA and overlap the coil conductor CW and may further extend to outer side portions of the coil opening CA and the coil conductor CW. In FIG. 10A, a cut may be included instead of the opening MA.

In the example illustrated in FIG. 10B, slit openings MC along the bending line BL-BL are defined through the magnetic-substance sheet 10. The location of the opening MC is an example of the “specific portion”. The total length of the openings MC is preferably about ½ or more the full width of the coil opening CA. Specifically, the total length of the openings MC is preferably about ⅔ or more the full width of the coil opening CA. The “total length of the openings MC” denotes the sum value of the longer side dimensions of the openings MC in a direction perpendicular or substantially perpendicular to a bending direction of the bending in a bending portion or the curving in a curving portion, that is, in a direction along the bending line BL-BL. Thus, magnetic fluxes escape from a portion without any magnetic substance, that is, from the openings MC in the bending portion.

In the example illustrated in FIG. 10C, cuts MS along the bending line BL-BL are provided through the magnetic-substance sheet 10. Because of being the cuts MS, no space is present in the cuts MS before the bending of the magnetic-substance sheet 10. The location of the cut MS is an example of the “specific portion”. The total length of the cuts MS is preferably about ½ or more the full width of the coil opening CA. Specifically, the total length of the cuts MS is preferably about ⅔ or more the full width of the coil opening CA. The “total length of the cuts MS” denotes the sum value of the longer side dimensions of the cuts MS in a direction perpendicular or substantially perpendicular to a bending direction of the bending in a bending portion or the curving in a curving portion, that is, in a direction along the bending line BL-BL. By bending the antenna along the bending line BL-BL, even a space in the cuts MS in an outer side portion of the bent magnetic-substance sheet 10 is able to be provided. Thus, magnetic fluxes escape from the cuts MS of the magnetic-substance sheet.

The openings MC or the cuts MS are not necessarily provided at both ends of the magnetic substance and may be provided only at one end of the magnetic-substance sheet. The cuts MS are not necessarily desired to be coupled to end portions of the magnetic substance, and the opening MA, the openings MC, and the cuts MS may be combined as appropriate.

Since the magnetic-substance sheet is not completely divided into two portions as in the antenna according to the present preferred embodiment illustrated in FIGS. 10A, 10B and 10C, a problem of positional deviation between two or more separate magnetic-substance sheets is unlikely to occur and a problem of positional deviation between the coil conductor and the magnetic-substance sheets is also unlikely to occur.

### SEVENTH PREFERRED EMBODIMENT

A seventh preferred embodiment of the present invention provides a relationship between a coil opening and a bending position of an antenna.

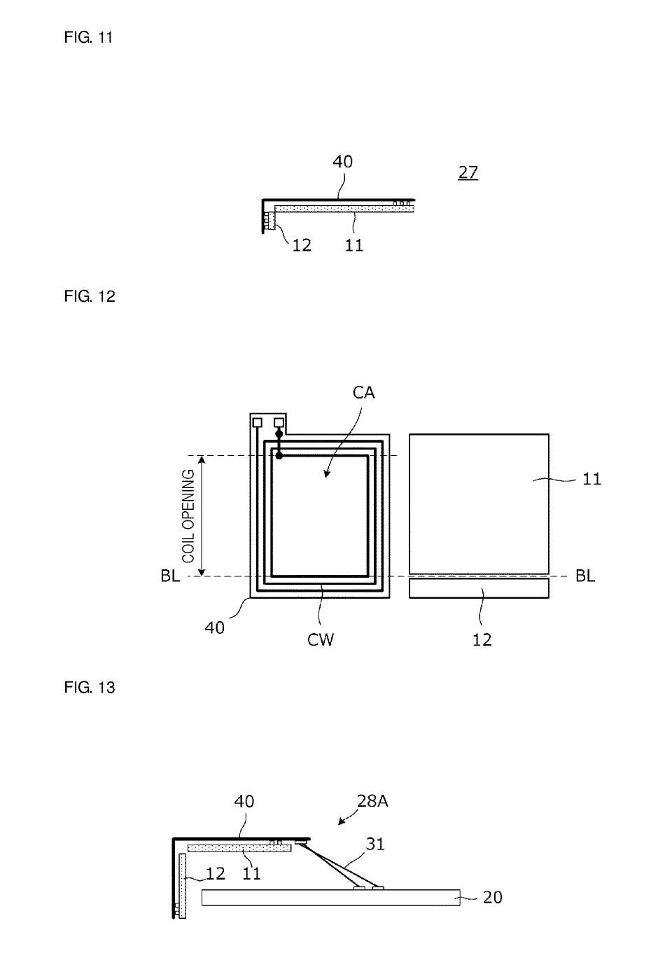

FIG. 11 is a front view of an antenna 27 according to the present preferred embodiment. FIG. 12 is an exploded plan view of the antenna 27 before attaching magnetic-substance sheets 11 and 12 to a flexible substrate 40.

In the present preferred embodiment, a bending line BL-BL is present at an end of a coil opening CA. The bending position of the antenna is not limited to a central portion of the coil opening CA. As in the present preferred embodiment, the antenna may be bent on a boundary between the coil opening CA and a coil conductor CW.

In the present preferred embodiment, the magnetic-substance sheets 11 and 12 are pasted on the surface of the flexible substrate 40 where the coil conductor CW is located. Thus, the magnetic-substance sheet may be located on the surface of the flexible substrate where the coil conductor CW is located or may be located on the opposite surface thereof.

### EIGHTH PREFERRED EMBODIMENT

An eighth preferred embodiment of the present invention includes a coupling structure between an antenna and a circuit board.

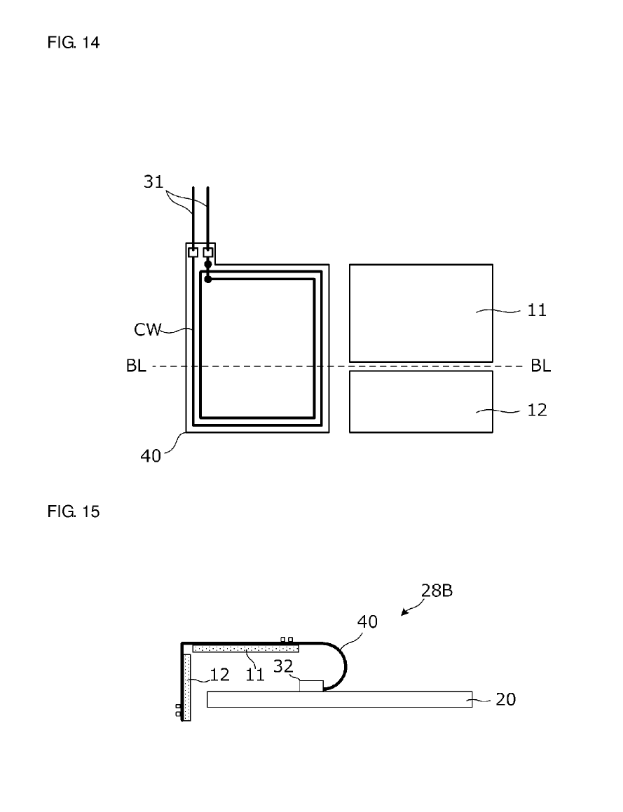

FIG. 13 is a front view that illustrates a main portion of the inside of an electronic device including an antenna 28A. FIG. 14 is an exploded plan view of the antenna 28A before attaching magnetic-substance sheets 11 and 12 to a flexible substrate 40. Lands are provided at both ends of a coil conductor CW on the flexible substrate 40 and an end of a wire 31 is coupled to the land. The other end of the wire is coupled to a land on the circuit board 20 as illustrated in FIG. 13. The features and elements of the antenna 28A are the same or similar to the features and elements of the antenna 21 described in the first preferred embodiment except that the magnetic-substance sheets 11 and 12 are pasted on the surface of the flexible substrate 40 on which the coil conductor CW is located.

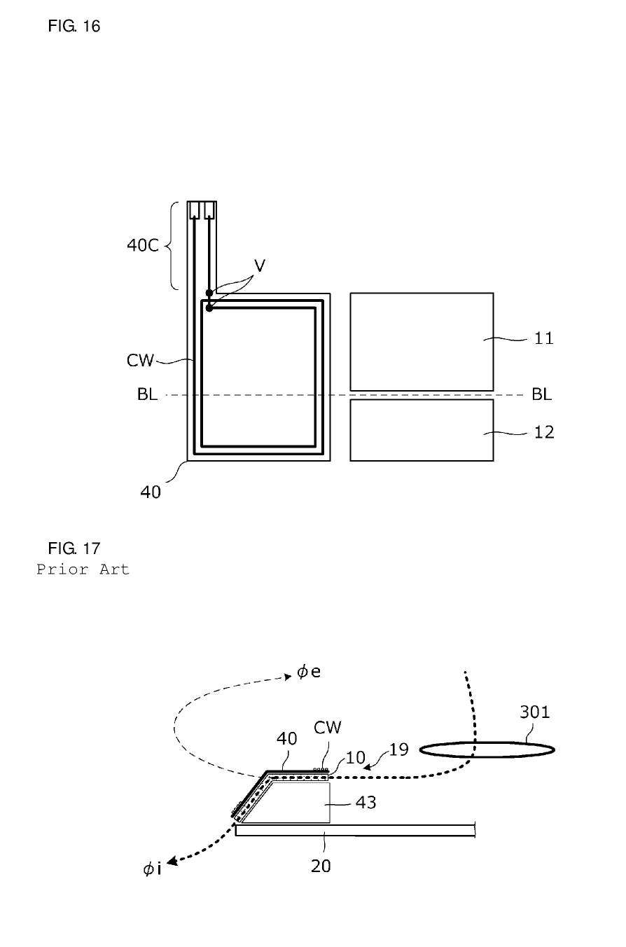

FIG. 15 is a front view that illustrates a main portion of the inside of an electronic device including an antenna 28B. FIG. 16 is an exploded plan view of the antenna 28B before attaching the magnetic-substance sheets 11 and 12 to a flexible substrate 40. A cable portion 40C that is an extension of both ends of the coil conductor CW is provided in the flexible substrate 40. A top end of the cable portion 40C is coupled to the circuit board 20 with a connector 32 interposed therebetween as illustrated in FIG. 15.

### OTHER PREFERRED EMBODIMENTS

Although in each of the preferred embodiments described above, the coil conductor CW is provided on a single side of the flexible substrate 40, for example, the coil conductor CW may be provided on both sides of the flexible substrate 40. The coil conductor may include, for example, the coil conductor CW provided over layers in a multilayer board.

Although in each of the preferred embodiments described above, the coil conductor CW is provided on the flexible substrate 40, for example, the coil conductor CW is not limited to the structure where the coil conductor CW is provided on the flexible substrate 40. The coil conductor may be provided directly on a casing by laser direct structuring (LDS) or may include a wire and the like.

The magnetic-substance sheet may be provided by making a sintered magnetic-substance ferrite plate into small pieces and pasting the small pieces on a resin base material instead of mixing powder of a magnetic substance, such as magnetic-substance ferrite, with resin and making the mixture into a sheet.

The magnetic-substance sheet and the flexible substrate may be joined to each other by an adhesive instead of a double-surface adhesive sheet.

Although in each of the preferred embodiments described above, an antenna device and an electronic device in a communication system that mainly utilizes magnetic-field coupling, such as NFC, are described, the antenna device and the electronic device according to each of the preferred embodiments described above may also be similarly applied to a noncontact power transfer system in an electromagnetic induction or magnetic-field resonance scheme, which utilizes magnetic-field coupling. For example, the antenna device according to each of the preferred embodiments described above may be applied to a power reception antenna device of a power reception device with a noncontact power transfer system in a magnetic-field resonance scheme, which operates in a frequency band lower than a UHF band, such as an HF band, and particularly communicates at a frequency of 6.78 MHz or a frequency near 6.78 MHz, and may be applied to a power transmission antenna device of a power transmission device. Even in this case, the antenna device defines and functions as the power reception antenna device or the power transmission antenna device. Even in this case, both ends of the coil conductor of the coil antenna in the antenna device are coupled to a power reception circuit or a power transmission circuit that operates the communication frequency band, such as an HF band, particularly frequencies near 6.78 MHz, for example. The power reception circuit includes a rectifier circuit that is coupled to the coil antenna and a load and converts electric power from the coil antenna into direct current (DC) to supply the DC to the load, and may also include a smoothing circuit, a DC-DC converter circuit, and the like. The power transmission circuit includes an inverter circuit that supplies electric power to the coil antenna.

Lastly, the descriptions of the preferred embodiments described above are examples in all respects and not restrictive. Alternatives and variations are possible for persons skilled in the art as appropriate. For example, partial replacement or combination in configurations described in different preferred embodiments is possible. The scope of the present invention is not represented by the preferred embodiments described above but by the claims. Further, the scope of the present invention is intended to include all variations within meanings and a scope that are equivalent to the claims.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An antenna comprising:
a spiral coil conductor that includes a coil opening; and
a first magnetic sheet and a second magnetic sheet that are each located along the coil opening; wherein
the spiral coil conductor includes a curving portion that curves or a bending portion that bends toward a side on which both of the first magnetic sheet and the second magnetic sheet are located;
the curving portion or the bending portion is provided in the coil opening; and
the first magnetic sheet and the second magnetic sheet are provided at positions except a specific portion that is at least a portion of the curving portion or the bending portion.

2. An electronic device comprising:
a casing; and
an antenna provided inside the casing; wherein
the antenna includes:
a spiral coil conductor that includes a coil opening; and
a first magnetic sheet and a second magnetic sheet that are each located along the coil opening;
the spiral coil conductor includes a curving portion that curves or a bending portion that bends toward a side on which both of the first magnetic sheet and the second magnetic sheet are located;
the curving portion or the bending portion is provided in the coil opening; and
the first magnetic sheet and the second magnetic sheet are provided in positions except a specific portion that is at least a portion of the curving portion or the bending portion.

3. The electronic device according to claim 2, wherein the antenna is located along an inner surface of the casing.

4. The electronic device according to claim 2, wherein the antenna is located in an end portion of the casing.

5. The electronic device according to claim 2, further comprising a plane conductor located closer to the first magnetic sheet or the second magnetic sheet than to the spiral coil conductor.

6. The electronic device according to claim 2, wherein the spiral coil conductor is provided on a flexible substrate.

7. The electronic device according to claim 6, wherein the first magnetic sheet and the second magnetic sheet are each pasted over the flexible substrate.

8. The electronic device according to claim 2, wherein each of the first magnetic sheet and the second magnetic sheet includes a mixture of a magnetic powder and a resin material.

9. The electronic device according to claim 2, wherein a gap without any magnetic sheet is located between the first magnetic sheet and the second magnetic sheet.

10. The electronic device according to claim 9, wherein the gap includes an adhesive sheet.
